(19) United States
(12) Patent Application Publication
(10) Pub. No.: US 2018/0064064 A1
(43) Pub. Date: Mar. 8, 2018

(54) WATER DISPENSER DEVICE

(71) Applicant: AVI SAYAG, DALLAS, TX (US)

(72) Inventor: AVI SAYAG, DALLAS, TX (US)

(21) Appl. No.: 15/258,891

(22) Filed: Sep. 7, 2016

(51) Int. Cl. A01K 7/02; B67D 3/00

(52) U.S. Cl. CPC A01K 7/025; B67D 3/0035

(57) ABSTRACT

A dispenser device comprising a base configured to support a container, the container being at least partially filled with a fluid; a duct in communication with the base; a collar coupled to the duct, the collar configured to seal around a portion of the container; and a valve coupled to the duct and configured to selectively dispense fluid from the container.

### BACKGROUND

### 1. Field of the Invention

The present application relates generally to water dispenser device, and in particular to a water bowl dispenser device and method that allows the bowl to be separated from the dispenser and cleaned separately.

### 2. Description of Related Art

Giving the household pet a good supply of water in crucial to maintaining the health and wellbeing of the pet. To this end, it is necessary to clean water bowls twice a day to keep germs, mold and algae under control. Pet water bowls with integrated water containers are convenient. However, when water in the water container is in contact with the bowl water, the container water becomes contaminated and the water container must be replaced when the bowl is cleaned. In addition, pet owners have become more conscious of the water their pets drink, and have started to use higher quality water such as that provided by water delivery services. The cost of this water makes it necessary to avoid its contamination during water bowl use.

It is desired that a device be developed that allows the water bowl to be detachable from the base such that the water bowl may be cleaned separately. In addition the water in the bowl must not contaminate the water in the base and container. Although great strides have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of the dispenser device according to an embodiment of the current invention.

FIG. 2 is a cross section of the dispenser device of FIG. 1, showing greater detail.

While the assembly and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method in accordance with the present application overcomes one or more of the above-discussed problems commonly associated with conventional water bowl dispenser devices. The water bowl dispenser device and method according to the present application is configured to prevent the water in the container from being contaminated with water from the bowl. The bowl is removable allowing the bowl to be washed separately. The water container remains connected to the base while the bowl is being washed. These and other unique features of the system and method are discussed below and illustrated in the accompanying drawings.

The system and method will be understood, both as to its structure and operation, from the accompanying drawings, taken in conjunction with the accompanying description. Several embodiments of the assembly are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The dispenser device includes a base, supporting a container, the container being at least partially filled with water. A collar seals around a portion of the container, the collar being coupled to a duct which conveys water to a valve. The valve selectively dispenses the water into a bowl without water from the bowl contaminating water in the duct and the water container. A shroud may also be used to shield the valve and duct. Other fluids other than water may be dispensed with this device.

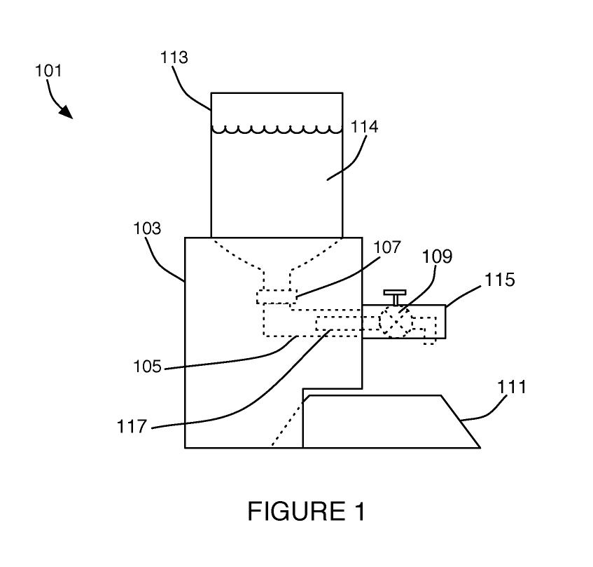

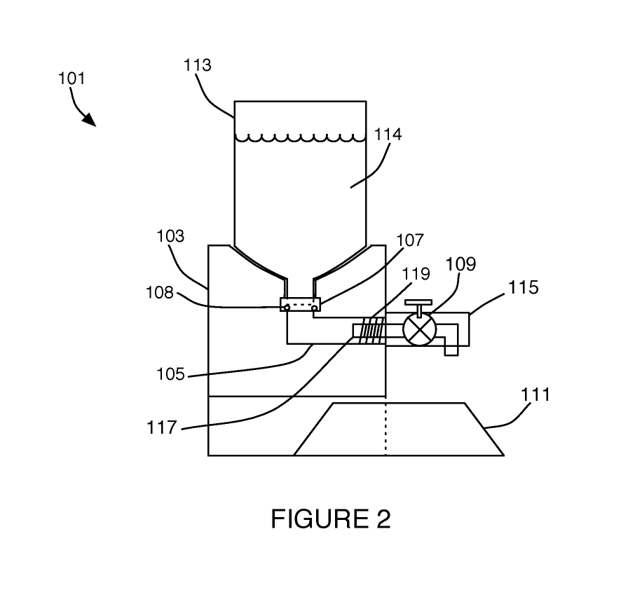

Referring now to the drawings wherein like reference characters identify corresponding or similar elements in form and function throughout the several views. FIG. 1 illustrates the dispenser device of the present application with internal details shown in dashed lines. FIG. 2 is a cross section of the embodiment of FIG. 1, allowing greater detail to be shown. Referring now to both FIGS. 1 and 2, System 101 comprises a base 103, a duct 105, a collar 107, and a valve 109. Base 103 is configured to support a container 113, container 113 being at least partially filled with a fluid 114. Container 113 is configured to be inverted so as to orient an opening in a downward orientation for fluid to be selectively removed. Container 113 contacts and seals against collar 107. Collar 107 includes a seal 108 to prevent leakage of fluid 114 from container 113.

Duct 105 is formed at least partially formed within base 103. Duct 105 is configured to hold a volume of the fluid 114 from container 113. Collar 107 is coupled to duct 105 such that fluid leaving container 114 flows into and through duct 105. Valve 109 is coupled to duct 105. Valve 109 is configured to selectively dispense fluid from the container.

Duct 105 may also include one or more pipes 117. A portion of the pipe 117 may be located externally as seen in the figures and/or internally within the base 103. A portion of the pipe may also be removable from the base using one or more sets of threads 119. Other methods of joining pipes 117 may be contemplated.

System 101 may also include a bowl 111, configured to receive fluid from valve 109. Bowl 111 is independent from base 103 and configured to separate from base 103. Base 103 is further configured to accept at least part of bowl 111. In this manner bowl 111 may be conveniently stored in base 103 or pulled out to be adjacent to base 103. Bowl 111 may be cleaned separately from base 103, allowing container 113 to remain sealed to collar 107. Valve 109 is located such that the fluid dispensed from valve 107 does not contaminate fluid in channel 105. In one example, valve 107 is located high enough over bowl such that fluid does not flow from bowl 111 back through valve 107 to duct 105.

System 101 may also include a shroud 115 which is configured to shield at least a portion of either valve 109 and/or duct 105. Shroud 115 may be made of any number of materials known to be suitable for moist environments. Shroud 115 may be removable and adjustable to different sized ducts 105 and valve 109 locations.

The current application has many advantages over the prior art including at least the following: (1) avoiding contamination of the fluid in the container with fluid from the bowl; (2) the bowl is removable allowing the bowl to be washed separately from the base; (3) the container remains connected to the duct in the base while the bowl is being washed.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A dispenser device comprising:
a base configured to support a container, the container being at least partially filled with a fluid;
a duct in communication with the base;
a collar coupled to the duct, the collar configured to seal around a portion of the container; and
a valve coupled to the duct and configured to selectively dispense fluid from the container.

2. The dispenser device of claim 1, further comprising a bowl being independent from the base, and configured to receive fluid released from the valve.

4. The dispenser device of claim 1, further comprising a shroud configured to shield a portion of at least one of the valve and the duct.

5. The dispenser device of claim 1, wherein the base is configured to accept at least part of a bowl.

6. The dispenser device of claim 1, wherein the duct is formed within the base.

7. The dispenser device of claim 1, wherein the duct includes one or more pipes.

8. The dispenser device of claim 7, wherein a portion of the pipe is external to the base.

9. The dispenser device of claim 7, wherein a portion of the pipe is removable from the base.

10. A method for dispensing fluid to a pet bowl comprising the steps of:
locating a container in communication with a base;
inserting the container into a collar, the collar configured to seal around a portion of the container;
locating a bowl adjacent to the base, the base configured to hold a volume of the fluid; and
selectively operating a valve in communication with the base to regulate the dispensing of the fluid into the bowl.

11. The method of claim 10, including the step of:
separating the container from the base.

12. The method of claim 10, including the step of:
separating the bowl from the base.

13. The method of claim 12, wherein the container remains sealed on the collar.
